(19) United States
(12) Patent Application Publication
(10) Pub. No.: US 2010/0294399 A1
(43) Pub. Date: Nov. 25, 2010

(54) WORKING PLATFORM PROVIDED WITH A MANUAL WOOD PLANER

(76) Inventor: Bor-Yann CHUANG, Taiping City (TW)

Correspondence Address: SINORICA, LLC, 2275 Research Blvd., Suite 500, ROCKVILLE, MD, 20850, US

(21) Appl. No.: 12/471,011

(22) Filed: May 22, 2009

(51) Int. Cl. B25H 1/02; B27C 1/14

(52) U.S. Cl. 144/286.5; 144/114.1

(57) ABSTRACT

A working platform provided with a manual wood planer is provided with a base the two sides of which are both formed with workbenches, a working platform being thereby formed. The workbench is formed with a pedestal and a granite slate is mounted at the top of pedestal. The slate is polished and ground into a working portion at the top, and a combination portion at the bottom, and several securing holes are on the combination portion. A strip-shaped hole opposite to each securing hole is formed. The position of slate may be tuned and the error margin of distance between the thru hole and the securing hole is allowed to avoid the slate, when being secured, from cracking. With the features of high level degree, low friction efficiency, and no internal stress that are provided in the granite, the working platform is featured with perfect processing accuracy and durability.

### BACKGROUND OF THE INVENTION

1. Field of the Invention

This invention relates to a working platform provided with a manual wood planer.

2. Description of the Prior Art

A conventional manual wood planer is provided with a base the two sides of which are both formed with workbenches, a working platform being thereby formed. The workbench is all made of a cast iron in one. The workbench is installed on the wood planer and then polished and ground with a grinder into a flat working plane. Thus, the workbenches at the two sides of base are made to be equally level for increasing the processing accuracy.

However, the workbench is made of the cast iron, so it not only easily get rusty but also is subject to higher friction. Besides, during the casting process, an internal stress even remains, which causes the workbench, after being polished and ground for a period of time, to be out of shape, and thus impacts the flatness of workbench. Further, because the working platform provided with a manual wood planer is assembled and then processed, although the workbenches at the two sides of base are equally level, higher cost is consumed and processing is more difficult; thus, it is apparent that improvement is necessarily made.

Consequently, because of the technical defects of described above, the applicant keeps on carving unflaggingly through wholehearted experience and research to develop the present invention, which can effectively improve the defects described above.

### SUMMARY OF THE INVENTION

A working platform provided with a manual wood planer is provided with a base the two sides of which are both formed with workbenches, a working platform being thereby formed. Each workbench is formed with a base onto which a granite slate is mounted with a securing part. The slate is polished and ground into a working portion at the top, and a combination portion at the bottom, and several securing holes are formed on the combination portion. On the base, an oval thru hole opposite to each securing hole is formed to adjust the position of slate, and the error margin of distance between the thru hole and the slate is allowed to avoid the slate, when being secured, from cracking. Further, a regulation hole is formed at one side of each thro hole on the base, through which a regulation screw bolt is provided and passes for adjustment the level degree of slate. Next, at least one buffer part is provided on the base to prevent the slate from being collided and damaged during installation. Thus, with the structure combined with the features of high level degree, low friction efficiency, and no internal stress that are provided in the granite, the working platform provided with a manual wood planer is thereby provided with perfect processing accuracy and durability.

### BRIEF DESCRIPTION OF THE DRAWINGS

FIG. 1 is a 3D exploded view of a preferred embodiment of the present invention;

FIG. 2 is a partially enlarged 3D view of the preferred embodiment of the present invention;

FIG. 3 is a partially enlarged and sectional view of the preferred embodiment of the present invention; and

FIG. 4 is a schematic view illustrating the operation of regulation screw bolt in the preferred embodiment of the present invention.

### DETAILED DESCRIPTION OF THE PREFERRED EMBODIMENTS

Now, the present invention will be described more specifically with reference to the following embodiments. It is to be noted that the following descriptions of preferred embodiments of the present invention are presented herein for purpose of illustration and description only; it is not intended to be exhaustive or to be limited to the precise form disclosed.

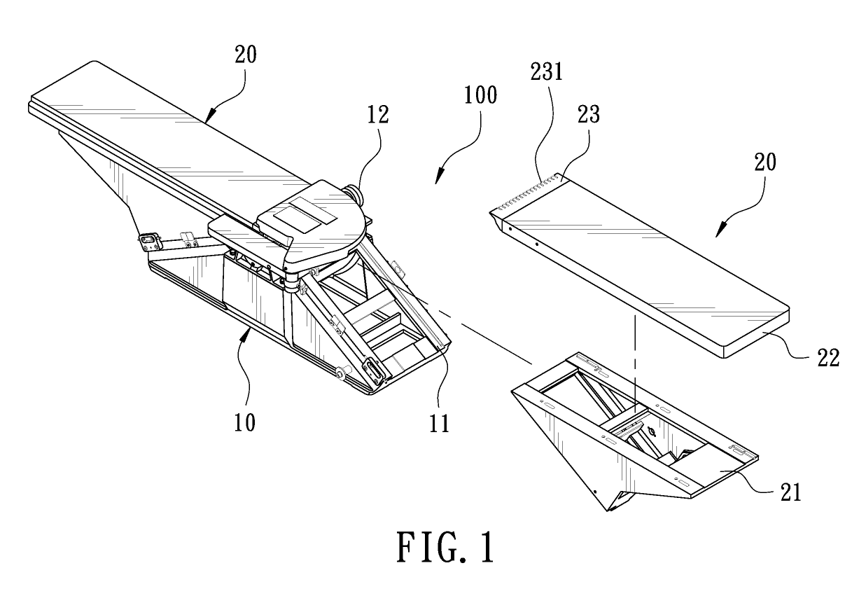

With reference to FIG. 1 shown as a 3D exploded view of a preferred embodiment of the present invention, a working platform 100 provided with a manual wood planer is mainly provided with a trapezoidal base 10. A chute 11 is formed on each of the two inclined sides of the base 10, and each of the sides is connected to a workbench 20, and a working platform is thereby formed. A plane iron unit 12 is provided between the workbenches 20 of the base 10. Each workbench 20 is provided with a pedestal 21. A granite slate 22 is mounted at the top of pedestal 21. A metallic link plate 23 is further provided at a side of the slate 22 that is near the plane iron unit 12. Several nicks 231 of equal intervals are formed at the free end of link plate 23 for achievement of fast cut of row.

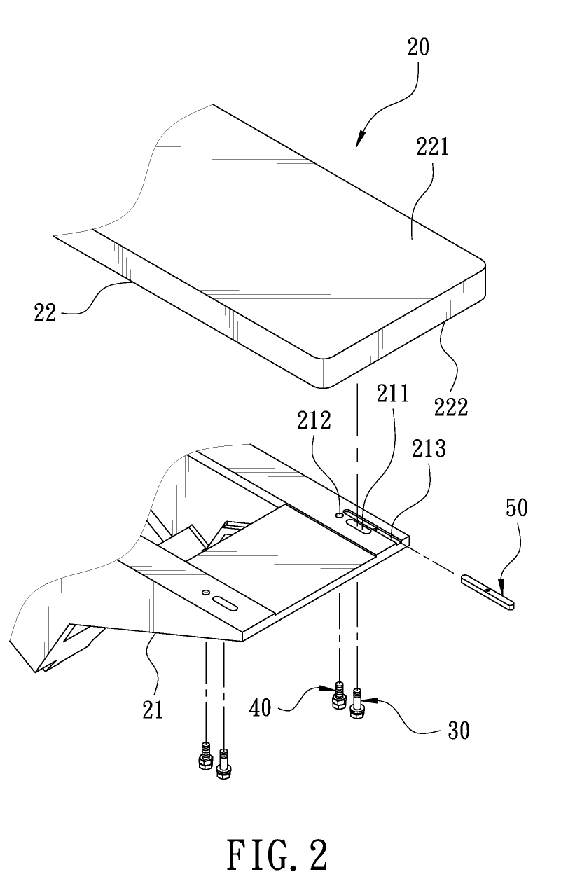

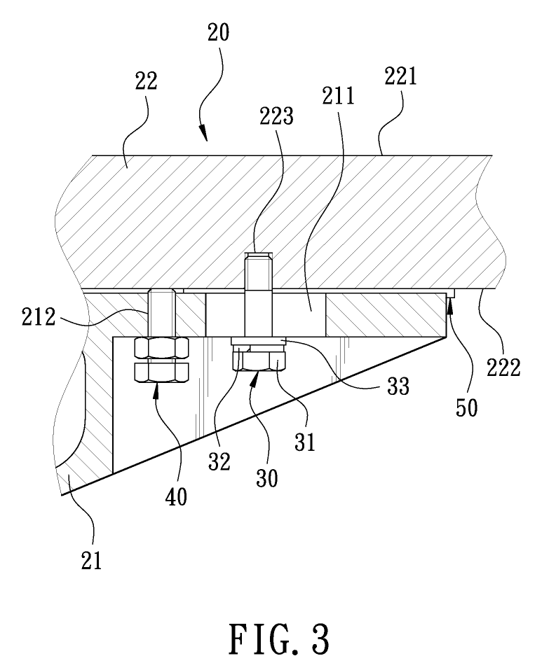

With reference to FIGS. 2 and 3, a partially enlarged and exploded 3D view and a partially enlarged sectional view of the preferred embodiment of the present invention, the slate 22 is polished and ground into a working portion 221 at the top, and a combination portion 222 at the bottom, and three securing holes 223 are formed at equal intervals near the left and right sides of combination portion 222. Being opposite to the top portion of pedestal 21, the securing hole 223 of slant 22 is formed with an oval thru ole 211, and a securing part 30 passes through the securing hole 223 to secure the slant 22. Further, a regulation hole 212 is formed at one side of each thru hole 211 on the pedestal 21, through which a regulation screw bolt 40 passes. Next, each of the grooves 213 where a buffer part 50 is contained is formed at the front and rear edges of the top portion of pedestal 21. In the embodiment, the buffer part 50 is a gasket of rubber. The height of buffer part 50 is larger than the depth of groove 213, so the buffer part 50, when being placed in the groove 213, is slightly higher than the top portion of pedestal 21 to buffer the impact load caused when the pedestal 21 is combined with the slant 22, and thus to prevent the slant 22 from being damaged.

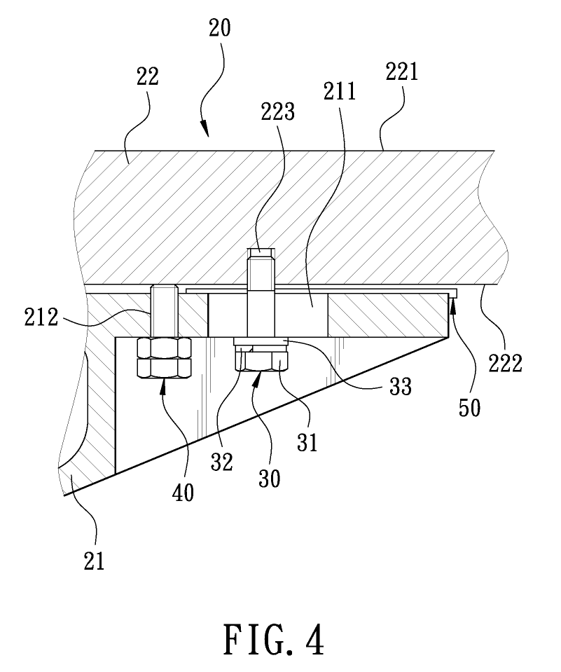

With reference to FIGS. 1 and 3, the granite is hard and fragile, and is poor in ductility, so each securing hole 223 is formed on the slant 22 and an oval thru hole 211 is formed opposite to each securing hole 223 on the pedestal 21, which allows the tolerance of distance from the securing hole 223 to the thru hole 211 to prevent the slant 22, when being secured, from crackling, and which allows adjustment of the position of slant 22. Further, in this embodiment, the securing part 30 is a screw bolt 31 around which a spring gasket 32 and a flat washer 33 are set. Thus, it prevents the slant 22, when being excessively secured, from cracking and may damp the operating workbench 20 from vibrating to prevent the screw bolt 31 from being loose. Besides, with reference to FIG. 4, when the securing part 30 is not fastened, the regulation screw bolt 40 may be used to regulate the level degree of slant 22 and thus the workbenches 20 at the two sides of base 10 may be equally level. Thus, with the structure combined with the features of high hardness, high level degree, and low friction efficiency that are provided in the granite, the working platform 100 provided with a manual wood planer is thereby featured with perfect processing accuracy, low rust degree, and no deformation behavior.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A working platform provided with a manual wood planer, being provided with a base the two sides of which are both formed with workbenches, a working platform being thereby formed, a plane iron unit being provided between the workbenches of the base, being characterized in that:
the workbench is provided with a pedestal the top of which is formed with a slant, in which the slant defines a working portion at the top, and a combination portion at the bottom, several securing holes are formed on the combination portion, and a long strip-shaped thru hole opposite to each securing hole is formed on the pedestal, through which a securing part passes to be fixed onto the securing hole of the slant, making the slant to be combined and fixed onto the pedestal.

2. The working platform provided with the manual wood planer according to claim 1, wherein the slant is of granite.

3. The working platform provided with the manual wood planer according to claim 1, wherein the thru hole is preferably long oval.

4. The working platform provided with the manual wood planer according to claim 1, wherein the securing part is a screw bolt around which at least one spring gasket is set.

5. The working platform provided with the manual wood planer according to claim 1, wherein at least one regulation hole is formed at one side of each thru hole of the base.

6. The working platform provided with the manual wood planer according to claim 5, wherein a regulation screw bolt is provided passing through each regulation hole and the end of each regulation screw bolt stays close to the combination portion of slant.

7. The working platform provided with the manual wood planer according to claim 1, wherein at least one groove is formed on the pedestal, a buffer part is provided in the groove, and the height of buffer part is larger than the depth of groove, so the buffer part, when being placed in the groove, is slightly higher than the top portion of pedestal.

8. The working platform provided with the manual wood planer according to claim 7, wherein the buffer part is a gasket of rubber.

9. The working platform provided with the manual wood planer according to claim 1, wherein a metallic link plate is further provided at a side of the slate on each workbench that is near the plane iron unit and several nicks of equal intervals are formed at the free end of link plate.
